(19) United States
(12) Patent Application Publication
(10) Pub. No.: US 2026/0028523 A1
(43) Pub. Date: Jan. 29, 2026

(54) CHELATING AGENT- FREE TREATMENT FLUIDS AND RELATED METHODS FOR TREATING SCALE DEPOSITS

(71) Applicant: SAUDI ARABIAN OIL COMPANY, Dhahran (SA)

(72) Inventors: Faisal M. ALISSA, Dhahran (SA); Abdulrahman S. ALSULMI, Thuwal (SA); Jehad K. EL-DEMELLAWI, Thuwal (SA); Tariq ALMUBARAK, Dhahran (SA)

(73) Assignee: SAUDI ARABIAN OIL COMPANY, Dhahran (SA)

(21) Appl. No.: 18/782,361

(22) Filed: Jul. 24, 2024

(51) Int. Cl. C09K 8/528

(52) U.S. Cl. CPC C09K 8/528

(57) ABSTRACT

Methods for reducing and/or preventing scale deposits comprising: contacting one or more components with a treatment fluid, the treatment fluid comprising a mixture of: an aqueous base fluid; an alkaline descaling agent; and a polyacid, thereby reducing the scale deposits on said one or more components, and reducing the formation of pseudo-scale deposits on said one or more components. The treatment fluids may optionally comprise a water-wetting surfactant, a demulsifier, and/or a mutual solvent.

### FIELD OF THE DISCLOSURE

The present disclosure generally relates to treatment fluids and methods of use thereof for reducing scale deposits; more particularly, the present disclosure relates to chelating agent-free treatment fluids and methods of use thereof for reducing scale deposits in pipelines, tubing or other equipment used in the oil and gas industry.

### BACKGROUND OF THE DISCLOSURE

Scale formation in pipelines, tubing, and other equipment used in the oil and gas industry is a significant issue, impacting the efficiency and safety of operations. The problems associated with scale formation can be extensive and multifaceted. Some of the resulting issues include reduced flow capacity, increased pressure drop, corrosion, operational downtime, heat transfer efficiency, product contamination, and safety hazards. Additionally, when present in a wellbore or in the formation surrounding a wellbore, scale deposition can jeopardize wellbore integrity and cause production instability.

Scale, in the context of pipelines and industrial systems, refers to the hard, crystalline deposits that form on the internal surfaces of pipes, heat exchangers, and other equipment. These deposits are typically composed of minerals that precipitate out of solution when certain conditions, such as temperature, pressure, and chemical composition, change. The most common types of scale include calcium carbonate (CaCO₃), calcium sulfate (CaSO₄), barium sulfate (BaSO₄), and silica (SiO₂). For example, barium sulfate forms in the presence of barium and sulfate ions, often in oil and gas production where formation water mixes with injected seawater. Its appearance is white, very hard, and dense. Barium sulfate often forms in oil and gas pipelines and production wells. Calcium sulfate scales, in particular, are a result of mixing incompatible waters such as seawater (rich in sulfate) and formation water (rich in calcium, strontium, and barium).

Mitigation methods to address scale include mechanical treatments as well as chemical treatments. Mechanical treatments involve mechanical reducing the scale deposits from the internal surfaces of the pipelines or equipment. A common device is known as a “pig,” which is inserted into the pipeline or equipment to, in effect, scrape off scale deposits as it moves through the pipe. Unfortunately, mechanical treatment is often not applicable/feasible due to the size of the pipeline.

Alternatively, chemical treatments are a common method to mitigate scale. Such chemical treatments often involve acids (such as hydrochloric acid or acetic acid), and chelating agents (such ethylenediaminetetraacetic acid (EDTA), tetrasodium ethylenediaminetetraacetic acid (Na4-EDTA), hydroxyethylenediaminetriacetic acid (HEDTA), diethylenetriaminepentaacetic acid (DTPA), L-glutamic-N,N-diacetic acid methylglycinediacetic acid (GLDA), (MGDA), nitrilotriacetic acid (NTA), hydroxyethyliminodiacetic acid (HEIDA), cyclohexylenediaminetetraacetic acid (CDTA), diphenylaminesulfonic acid (DPAS), ethylenediaminedi (o-hydroxyphenylacetic) acid (EDDHA), glucoheptonic acid, gluconic acid, citric acid, tetrasodium aspartate diacetate (Na4-ASDA), ethylenediamine-N,N′-disuccinic acid (EDDS), and the like, salts thereof, and any combination thereof). These chemicals work by altering the solubility of the scale-forming minerals or by disrupting their crystal growth, thus maintaining pipeline integrity and optimizing flow efficiency. While scale removal chemicals can be effective in dissolving and reducing scale deposits, they come with several problems and disadvantages that need to be carefully considered. These challenges include, but are not limited to, corrosion, handling/safety risks, environmental impact, and cost. In particular, the use of chelating agents, can have several challenges and disadvantages such as complex disposal requirements due to their biodegradability and cost (particularly when used in large quantities).

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method of reducing and/or preventing scale deposits is provided including: contacting one or more components with a treatment fluid, the treatment fluid comprising a mixture of: an aqueous base fluid; an alkaline descaling agent; and a polyacid, thereby reducing the scale deposits on said one or more components, and reducing the formation of pseudo-scale deposits on said one or more components.

In another embodiment consistent with the present disclosure, a treatment fluid capable of reducing and/or preventing scale deposits is provided including: an aqueous base fluid; an alkaline descaling agent capable of reducing scale deposits; and a polyacid capable of preventing formation of pseudo-scale deposits.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### DETAILED DESCRIPTION

The present disclosure generally relates to treatment fluids and methods of use thereof for reducing scale deposits; more particularly, the present disclosure relates to chelating agent-free treatment fluids and methods of use thereof for reducing scale deposits in pipelines, tubing, or other equipment used in the oil and gas industry.

In various aspects, treatment fluids of the present disclosure comprise a mixture of an aqueous fluid, an alkaline descaling agent capable of reducing scale deposits, and a polyacid capable of preventing formation of pseudo-scale deposits. In various aspects, methods of the present disclosure comprise contacting components which may contact and/or include scale deposits and/or dissolved scale-forming ions in a treatment fluid of the present disclosure, thereby reducing and/or preventing formation of scale deposits on the components. An advantage of the treatment fluids of the present disclosure and methods of use thereof is the ability to prevent and/or remove scale without the use of chelating agents, and in various embodiments, treatment fluids of the present disclosure and/or methods of use thereof may exclude use of chelating agents. This allows operators to avoid many of the potential environmental and economic challenges associated with such chelating agents. In some embodiments, treatment fluids of the present disclosure and/or methods of use thereof may exclude chelating agents. Polyacids used in the present disclosure also may be capable of preventing formation of said pseudo-scale deposits. Further, in some embodiments, the required amount of polyacid in the treatment fluids to inhibit pseudo-scale deposit formation may be about 20 to 40 times less than what is often required by treatment fluids comprising chelating agents such as EDTA to achieve full pseudo-scale deposit formation inhibition, making the treatment fluids of the present disclosure and methods of use thereof environmentally advantageous.

A further benefit of the treatment fluids of the present disclosure and methods of use thereof is that the treatment fluids comprising the mixture of the alkaline descaling agent and the polyacid may be capable of simultaneously reducing scale deposits and preventing sedimentation of pseudo-scale deposits. This enables the use of the treatment fluids to remove scale and prevent pseudo-scale deposits via a one-step process, thus excluding the need for a second step, such as the addition of an acid solution, to remove pseudo-scale deposits.

As used herein, the term “scale deposits,” and grammatical variations thereof, generally refer to solid deposits of water-insoluble mineral precipitates formed upon contact between dissolved scale-forming ions, such as contact between dissolved scale-forming anions and scale-forming cations. Scale deposits may result from changes in temperature, pressure, pH, and chemical composition of the fluids being handled. As used herein, the term “scale-forming,” and grammatical variations thereof, generally refer to the ability of an ion to participate in formation of a scale deposit of the present disclosure. Scale deposits may include organic scale deposits and/or inorganic scale deposits. Organic scale deposits may include asphaltenes, paraffins, biofilms, other organic molecules, or combinations thereof. Inorganic scale deposits may comprise various silicon compounds, such as silica, or various reaction products scale-forming anions and cations. Common scale deposits include calcium carbonate, calcium sulfate, barium sulfate, strontium sulfate, iron sulfide, and the like, as well as combinations of these types of deposits.

As used herein, the term “pseudo-scale deposits,” and grammatical variations thereof, generally refer to scale deposits formed upon contact of treatment solutions of the present disclosure with one or more components in the presence of dissolved scale-forming cations (or anions), where said treatment solutions comprise dissolved scale-forming anions (or cations), such as after a treatment solution has dissolved a scale deposit from the components.

The treatment fluids of the present disclosure comprise an aqueous base fluid; an alkaline descaling agent; and a polyacid capable of preventing formation of pseudo-scale deposits. Treatment fluids may further comprise one or more additional additives, if desirable, which may include surfactants, demulsifiers, and/or mutual solvents to assist with dispersion, cleaning action, and the formation of emulsions. The treatment fluids of the present disclosure may have a pH value of from about 7 to about 14, including all values and subsets therebetween, including pH values of from about 11 to about 14.

Suitable base fluids include aqueous fluids suitable for use in a subterranean formation operation or a downstream operation. Suitable aqueous fluids may include fresh water, deionized water, stream water; municipal treated water, saltwater, brines, brackish water, partially desalinated water, wastewater, non-potable water, grey water, industrial process water, and purified wastewater; produced water, and flowback water; and any combination thereof. The base fluid may be present in a treatment fluid of the present disclosure in an amount of about 60 weight percent (wt %) to about 90 wt %, based on the total weight of the treatment fluids, including all values and subsets therebetween, including from about 75 wt % to about 85 wt %. A still further benefit is that the treatment fluids of the present disclosure and methods of use thereof may use various types of aqueous fluids such as freshwater, seawater, and produced water, in the treatment fluids. Because chemical methods for scale removal typically require large volumes of aqueous fluid, it is beneficial to be able to use produced water and seawater.

Suitable alkaline descaling agents include those that are capable of reducing scale deposits by dissolving the scale deposits and which are basic (i.e., higher pH) by nature. Examples may include ammonium salts, alkali metal salts, the like, and any combination thereof. Suitable ammonium salts and alkali metal salts may include, but are not limited to, ammonium and alkali metal hydroxides, bicarbonates, carbonates, the like, and any combination thereof. Suitable examples of ammonium and alkali metal carbonates may include ammonium carbonate, sodium carbonate, potassium carbonate, the like, and any combination thereof. Suitable examples of ammonium and alkali metal bicarbonates may include ammonium bicarbonate, sodium bicarbonate, potassium bicarbonate, the like, and any combination thereof. Suitable examples of ammonium and alkali metal hydroxides may include ammonium hydroxide, sodium hydroxide, potassium hydroxide, the like, and any combination thereof. Specific examples of suitable alkaline descaling agents include M₂CO₃ (wherein M=metal), NaOH, KOH, Na₂CO₃, K₂CO₃, NaHCO₃, KHCO₃, [NH₄]₂CO₃ and [NH₄]HCO₃. The alkaline descaling agent may be present in a treatment fluid of the present disclosure in an amount of about 1 weight percent (wt %) to about 50 wt %, based on the total weight of the treatment fluids, including all values and subsets therebetween, including from about 1 wt % to about 40 wt % or from about 5 wt % to about 20 wt %.

The treatment fluids of the present disclosure may include various polyacids capable of preventing formation of pseudo-scale deposits. These polymers are believed to work in the treatment fluids of this disclosure by interfering with the crystallization process of scale-forming minerals, thereby preventing their deposition on surfaces. Preventing formation of pseudo-scale deposits may include preventing the formation of pseudo-scale deposits in the treatment fluids, enhancing the dispersion stability of pseudo-scale deposits in the treatment fluids, and/or hindering the sedimentation or precipitation of pseudo-scale deposits in the treatment fluids.

Suitable polyacids may comprise carboxylic groups, phosphonic acid groups, sulfonic acid groups, boronic acid groups, the like, and any combination thereof. Suitable polyacids may include (meth)acrylic acid polymers, such as, but not limited to, polyacrylic acid, methacrylic acid, and copolymers thereof; acidic polysaccharides, such as, but not limited to, xanthan gum; acidic cellulosic polymers, such as, but not limited to, carboxymethyl cellulose; polystyrene sulfonic acid; polymaleic acids; polyphosphonates; polyasparates; polyepoxysuccinic acids; sulfonated polymers; and polyvinyl sulfonates; other acidic polymer scale inhibitors, such as those known in the oil and gas industry; the like; copolymers thereof, and combinations thereof. Considerations for selecting an appropriate polyacid for a given embodiment of a treatment fluid of this disclosure include the specific water chemistry involved, including the types and concentrations of scale-forming ions, temperature, pressure, compatibility, and environmental impact. The polyacids may be present in the treatment fluids at from about 0.01 wt % to about 1 wt %, based on the weight of the treatment fluids, including all values and subsets therebetween, including from about 0.015 wt % to about 0.1 wt % or from about 0.25 wt % to about 0.5 wt %. The polyacids may be present in the treatment fluids at from about 100 ppm to about 10,000 ppm, based on the weight of the treatment fluids, including all values and subsets therebetween.

The treatment fluids may include various additives, such as, but not limited to, surfactants, demulsifiers, and/or mutual solvents.

Suitable surfactants may include water-wetting surfactants, anionic surfactants, such as, but not limited to, alkylbenzene sulfonates, alpha-olefin sulfonates; nonionic surfactants, such as, but not limited to, ethoxylated alcohols, alkylphenol ethoxylates; zwitterionic surfactants, such as, but not limited to, betaines, and sulfobetaines. Suitable commercially available water-wetting surfactants include, but are not limited to, LOSURF-259 (available from Halliburton Energy Services at www.Halliburton.com) which may be a mixture of ethoxylated alcohols, naphthalene, heavy aromatic petroleum naptha, and isopropanol; NE-118 (available from Baker Hughes at www.bakerhughes.com); D-3 (available from NPS); F-103 (available from Schlumberger at www.slb.com) which may include polyglycol ether (23-40 wt %), propan-2-ol (15-25 wt %), 2-butoxyethanol (17-25 wt %), water (10-30 wt %); F-108 (available from Schlumberger at www.slb.com); F-111 (available from Schlumberger at www.slb.com); S-103 (available from TAQA at taqa.com); and combinations thereof. If used, a surfactant may be present in the treatment fluids at from about 0.01 wt % to about 5 wt %, based on the weight of the treatment fluids, including all values and subsets therebetween, including about 0.1 wt % to about 1 wt %. The water-wetting surfactants may be present in the treatment fluids at from about 1 gallon of chemical per thousand gallons of water (gpt) to about 10 gpt, based on the weight of the treatment fluids, including all values and subsets therebetween, including from about 1.5 gpt to about 2.5 gpt or about 2 gpt.

Suitable demulsifiers may include polyoxyethylene, polyoxypropylenc,

polyamines such as poloxamines, polyhexamethylene polyamines, polyamines with the formula (NH₂((CH₂)₆NH)ₓH where x=1-5 as disclosed in U.S. Pat. No. 4,411,814, incorporated in its entirety herein; betaines; alkylbetaines; siloxanes; polydimethylsiloxane-polyethylene oxide copolymers; copolymers thereof; the like; and combinations thereof. Further suitable demulsifiers include commercially available demulsifiers, such as, AS-7 (available from Halliburton at www.Halliburton.com), AS-6 (available from Baker Hughes at www.BakerHughes.com), W054 (available from Schlumberger at www.slb.com), W060 (available from Schlumberger at www.slb.com), ASA-3 (available from TAQA at www.taqa.com), the like, or combinations thereof. Preferred demulsifiers include those that are considered “green” in that they have advantageous environmental properties such as biodegradability and low to no toxicity. Suitable examples include those based on natural polymers (such as polysaccharides, proteins or other biopolymers), plant-based surfactants (such as alkyl polyglucosides, saponins, or other surfactants derived from plants), biodegradable solvents (such as ethyl lactate, d-limonene, and other solvents derived from natural sources), and enzymes (such as lipases, proteases, and other enzymes that break down emulsions). If included, a demulsifier should be included in a treatment fluid of this disclosure in an amount of about 0.01 wt % to about 5 wt %, based on the weight of the treatment fluids, including all values and subsets therebetween, including from about 0.1 wt % to about 2 wt %. Demulsifiers may be present in the treatment fluids at from about 1 gpt to about 20 gpt, based on the weight of the treatment fluids, including all values and subsets therebetween, including from about 4 gpt to about 6 gpt or about 5 gpt.

The treatment fluids of this disclosure may also include mutual solvents. As used herein, the term “mutual solvents,” and grammatical variations thereof, generally refer to solvents that are chemical agents that are soluble in both water and oil. They can enhance the effectiveness of a treatment fluid by improving the compatibility and mixing of aqueous and hydrocarbon phases. Mutual solvents may improve solubility of, and/or act as, water-wetting agents, demulsifiers, and/or interfacial tension reducers. Suitable mutual solvents include glycol-based mutual solvents, ethyleneglycolmonobutyl ether (EGMBE); methanol; SA-64 (available from Saudi Aramco at www.aramco.com); poly (ethylene glycol) butyl ethers; diethylene glycol monobutyl ether; methyl ether ketones; short-chain alcohols, such as, isopropanol; tetrahydrofuran; dioxane; dimethylformamide; and dimethylsulfoxide. If used, mutual solvents may be present in the treatment fluids at from about 0.1 wt % to about 20 wt %, based on the weight of the treatment fluids, including all values and subsets therebetween, including from about 1 wt % to about 10 wt %. Mutual solvents may be present in the treatment fluids at from about 10 gpt to about 110 gpt, based on the weight of the treatment fluids, including all values and subsets therebetween, including from about 40 gpt to about 60 gpt or about 50 gpt.

The treatment fluids of the present disclosure may be made by mixing the components in a suitable container such as a tank, such as, but not limited to, a frac tank, or other known containers and then placed (e.g., by pumping or injection) in the location of interest to address a scale deposit. For example, a treatment fluid may be jetted through a tubular for placement, followed by a soaking as necessary depending on the extent of the scale deposits. Optionally, the treatment fluid may be heated before, during, or after placement if desired, in some embodiments. Heating the fluid may aid the conversion reaction for the scale deposits and potentially increase the effectiveness of the treatment. Heating a treatment fluid of the present disclosure may involve using an external heat source, e.g., to heat components that have scale deposits, such as, a heater or wrapping pipelines with heating cloths. Alternatively, thermochemical fluids may be used to heat the treatment fluids, components, or both.

The present disclosure provides methods for preventing, removing, and/or reducing scale deposits, said methods comprising: contacting one or more components with a treatment fluid of the present disclosure that includes a mixture of: an aqueous fluid; an alkaline descaling agent; and a polyacid dispersing agent, thereby reducing and/or removing said scale deposits on the one or more components, if present, and/or reducing the deposition formation of pseudo-scale deposits on said one or more components. In various embodiments, methods use treatment fluids of the present disclosure. In some embodiments, the scale deposits may be reduced in an amount of about 78% to about 100% following treatment with a treatment fluid of the present disclosure.

Suitable examples of components for which the treatment fluids of the present disclosure may be useful include, but are not limited to, pipes, valves, pumps, tanks, heat exchangers, filters, strainers, reactors, manifolds, separators, condensers, evaporators, flow meters, nozzles, spray towers, tubing, coiled tubing, production tubing, pumps, valves, storage tanks, boilers, cooling towers, flowlines, and the like. These industrial systems include components which may contact and/or contain flowing liquids comprising scale and/or scale- forming ions, including, but not limited to, for example, pipes or pipe systems. As used herein, the term “pipe system,” and grammatical variations thereof, generally refers to a network of conduits (including pipes, tubes, and the like), fittings, valves, and/or other components that transport fluids and gases in a variety of industries. The pipe systems may include pipes that may be from about 2 inches to about 60 inches in diameter, including all values and subsets therebetween, including about 2 inches or about 10 inches. Pipes where scale may build up may be from about 6 inches to about 50 km in length, including all values and subsets therebetween, including about 10 km. Pipes where scale may build up may include fluid transmission pipes.

Contacting the treatment solutions with the one or more components may include pumping, jetting, soaking, the like, or any combination thereof. Pumping may be used to contact and/or fill the components with the treatment solutions. Pumping may comprise contacting and/or filling a portion of the length of, or the entire length of, a component with the treatment solution. Pumping may contact and/or fill at least 75 percent by volume (vol %) of said filled length with the treatment solution.

The methods may include jetting the components with the treatment fluids. As used herein, the term “jetting,” and grammatical variations thereof, generally refers to spraying a high-pressure jet of aqueous-based fluid from a nozzle onto a component surface, such as the inner surface of a pipe. Jetting may be a more effective method of mechanically reducing scale deposits from components as compared to low pressure contacting methods such as pumping or soaking.

The methods may include ultrasonication of the components with the treatment fluids. As used herein, the term “ultrasonication,” and grammatical variations thereof, generally refers to the use of sound waves on components herein. The sound waves may be from about 5 kHz or greater or about 8 kHz to about 20 kHz. Ultrasonication may create cavitation bubbles in or near components to reduce or remove scale deposits. The ultrasonication may be performed by ultrasonic transducers or probes, which may be placed inside or on or near components. Jetting and sonication may or may not be used contemporaneously.

The methods may include soaking the components in the treatment fluid or contacting the components with the treatment fluid as it recirculates. As used herein, the term “soaking,” and grammatical variations thereof, generally refers to prolonged immersion of the one or more components in the treatment solution. Soaking may occur after pumping or jetting of the treatment solution, such that the one or more components are at least partially immersed in the treatment solution. The soak time may be from about five minutes to about two weeks, including all values and subsets therebetween, including from about 1 day to about one week. Jetting performed prior to soaking of the components in the treatment fluid may be a more effective method of mechanically removing scale deposits from components as compared to soaking alone.

Treatment fluids may further comprise additional additives, such as surfactants, demulsifiers, mutual solvents, the like, or any combination thereof. A still further benefit of the treatment fluids of the present disclosure and methods of use thereof is that the inclusion of such surfactants, demulsifiers, and mutual solvents in the treatment fluids does not limit or reduce the performance of the treatment fluids for reducing scale deposits and/or preventing pseudo-scale deposit formation. These components may assist in the dispersion and cleaning action and may also prevent the formation of emulsions.

### Non-Limiting Clauses

The present disclosure is further directed to the following non-limiting clauses:
Clause 1: A method of reducing and/or preventing scale deposits comprising: contacting one or more components with a treatment fluid, the treatment fluid comprising a mixture of: an aqueous base fluid; an alkaline descaling agent; and a polyacid, thereby reducing the scale deposits on said one or more components, and reducing the formation of pseudo-scale deposits on said one or more components.
Clause 2: The method of clause 1, wherein the one or more components comprises a portion of a pipeline or tubing system.
Clause 3: The method of clauses 1 or 2, wherein reducing the scale deposits on said one or more components results in an about 78% to about 96% reduction.
Clause 4: The method of any of clauses 1-3, further comprising: heating the

one or more components and/or the treatment fluid.
Clause 5: The method of any of clauses 1-4, wherein, while contacting the one or more components with the treatment fluid, the method further comprises: soaking the one or more components in the treatment fluid; and/or recirculating the treatment fluid.
Clause 6: The method of any of clauses 1-5, wherein the scale deposit comprises a sulfate.
Clause 7: The method of any of clause 1-6, wherein the alkaline descaling agent comprises at least one of: NaOH, KOH, Na₂CO₃, K₂CO₃, NaHCO₃, KHCO₃, and NH₄HCO₃.
Clause 8: The method of any of clauses 1-7, wherein the polyacid comprises at least one of: polyacrylic acid, carboxymethyl cellulose, and copolymers thereof.
Clause 9: The method of any of clauses 1-8, wherein the treatment fluid comprises at least one of: a water-wetting surfactant, a demulsifier, and a mutual solvent.
Clause 10: The method of clause 9, wherein: the water-wetting surfactant comprises at least one of: alkylbenzene sulfonates, alpha-olefin sulfonates, ethoxylated alcohols, alkylphenol ethoxylates, betaines and sulfobetaines; the demulsifier comprises at least one of: polyoxyethylene, polyoxypropylene, polyamines, poloxamines, polyhexamethylene polyamines, polysaccharides, and ethyl lactate; and/or the mutual solvent comprises at least one of: ethylene glycol monobutyl ether and tetrahydrofuran.
Clause 11: A treatment fluid comprising a mixture of: an aqueous base fluid; an alkaline descaling agent capable of reducing scale deposits; and a polyacid capable of preventing formation of pseudo-scale deposits.
Clause 12: The treatment fluid of clause 11, wherein the scale deposit comprises a sulfate.
Clause 13: The treatment fluid of clauses 11 or 12, wherein the alkaline descaling agent comprises at least one of: NaOH, KOH, Na₂CO₃, K₂CO₃, NaHCO₃, KHCO₃, and NH₄HCO₃.
Clause 14: The treatment fluid of any of clauses 11-13, wherein the polyacid comprises at least one of: polyacrylic acid, carboxymethyl cellulose, and copolymers thereof.
Clause 15: The treatment fluid of any of clauses 11-14, wherein the treatment fluid comprises: the alkaline descaling agent, present in an amount of 5 weight (wt %) to 20 wt %, based on the total weight of the treatment fluid.
Clause 16: The treatment fluid of any of clauses 11-15, wherein the treatment fluid comprises: the polyacid, present in an amount of 0.25 weight (wt %) to 0.5 wt %, based on the total weight of the treatment fluid.
Clause 17: The treatment fluid of any of clauses 11-16, wherein the treatment fluid comprises at least one selected from the group consisting of: a water-wetting surfactant, a demulsifier, and a mutual solvent.
Clause 18: The treatment fluid of clause 17, wherein: the water-wetting surfactant comprises at least one of: alkylbenzene sulfonates, alpha-olefin sulfonates, ethoxylated alcohols, alkylphenol ethoxylates, betaines and sulfobetaines; the demulsifier comprises at least one of: polyoxyethylene, polyoxypropylene, polyamines, poloxamines, polyhexamethylene polyamines, polysaccharides, and ethyl lactate; and/or the mutual solvent comprises at least one of: ethylene glycol monobutyl ether and tetrahydrofuran.
Clause 19: The treatment fluid of clauses 17 or 18, wherein the treatment fluid comprises at least one selected from the group consisting of: the water-wetting surfactant, present in an amount of 0.25 weight (wt %) to 0.5 wt %; the demulsifier, present in an amount of 0.01 wt % to 5 wt %; and the mutual solvent, present in an amount of 0.1 wt % to 20 wt %, based on the weight of the treatment fluid.

### EXAMPLES

To facilitate a better understanding of the embodiments of the present disclosure, the following examples of preferred or representative embodiments are given. In no way should the following examples be read to limit, or to define, the scope of the invention.

Dissolution experiments were performed with different alkaline descaling agents to determine their performance in dissolving calcium sulfate as an exemplary scale deposit. Beakers with 0.25 molar (M) and 1.25 M solutions of each alkaline descaling agent were combined with 5 grams (g) and 10 g of calcium sulfate, respectively. After reaction, the solutions were filtered, and the solid phase was washed with 10 milliliters (mL) of hydrochloric acid (HCl) (15 wt %) to remove the converted solids (calcium carbonate and calcium hydroxide are acid soluble). The ability to convert the calcium sulfate was measured in terms of weight percentage and is shown in Table 1.

TABLE 1

| | Weight |
|---|---|
| Alkaline | Percentage |
| Descaling | of Scale |
| Agent | Converted |
| NaHCO₃ | 78 |
| KHCO₃ | 86 |
| NH₄HCO₃ | 92 |
| Na₂CO₃ | 92 |
| K₂CO₃ | 96 |
| NaOH | 83 |
| KOH | 84 |

Below are example chemical components and concentrations for treatment fluids of this disclosure.

TABLE 2

| Exemplary Chemical Components | | Quantity | |
|---|---|---|---|
| Water | Freshwater, Seawater, | 1 barrel | |
| | Produced water | (159 L) | |
| Alkaline | NaOH, KOH, Na₂CO₃, | 8-30 | kg |
| Descaling Agent | K₂CO₃, NaHCO₃, | | |
| | KHCO₃ NH₄HCO₃ | | |
| Polyacid | Polyacrylic acid, | 0.795 | kg |
| | Carboxymethyl | | |
| | Cellulose | | |
| Water-Wetting | F-103, F-111 | 0.318 | L |
| Surfactant | | | |
| Demulsifier | AS-7, AS-6, ASA-07, | 0.795 | L |
| | W054, ASA-3 | | |
| Mutual Solvent | EGMBE, SA-64 | 7.95 | kg |

The following is a proposed example for a method of use for a treatment fluid from Table 2 to remove scale.

In small oilfield sites, a 10-inch trunk line is used to transport produced fluids to the gas/oil separation plant (GOSP). A 10-inch trunk line with a length of 10 km has an estimated volume of 3,000 barrels. The chemical components from Table 2 are mixed using six frac tanks (500 barrel capacity each) to make a treatment fluid. Each frac tank has the appropriate amount of additives and four tons of alkaline descaling agent.

The method includes jetting the treatment fluid through the 10-inch trunk line. Heating is optionally included. Heating may be by heating the pipe or by introducing thermochemical fluids. The treatment fluid may optionally be left to soak the scale. Depending on the extent of the scale, the soak time can range from one day to one week.

Table 3 shows the results of scale removal with different water types.

TABLE 3

| | Performance using |
|---|---|
| | K₂CO₃ as alkaline |
| Water type | descaling agent |
| Deionized water | 97.0% |
| Freshwater (e.g., Aquafina | 96.8% |
| commercial water) | |
| Seawater (e.g., Red Sea water) | 95.6% |
| Produced water (e.g., from a | 96.1% |
| Saudi Aramco field) | |

As shown by Table 3, the treatment fluids are effective with different types of aqueous fluid types, with only a 1-3% decrease in effectiveness.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentec. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A method of reducing and/or preventing scale deposits comprising:
contacting one or more components with a treatment fluid, the treatment fluid comprising a mixture of:
an aqueous base fluid;
an alkaline descaling agent; and
a polyacid,
thereby reducing the scale deposits on said one or more components, and/or
reducing the formation of pseudo-scale deposits on said one or more components.

2. The method of claim 1, wherein the one or more components comprises a portion of a pipeline or tubing system.

3. The method of claim 1, wherein reducing the scale deposits on said one or more components results in an about 78% to about 96% reduction.

4. The method of claim 1, further comprising
heating the one or more components and/or the treatment fluid.

5. The method of claim 1, wherein, while contacting the one or more components with the treatment fluid, the method further comprises:
soaking the one or more components in the treatment fluid; and/or recirculating the treatment fluid.

6. The method of claim 1, wherein the scale deposit comprises a sulfate.

7. The method of claim 1, wherein the alkaline descaling agent comprises at least one of:
NaOH, KOH, Na₂CO₃, K₂CO₃, NaHCO₃, KHCO₃, and NH₄HCO₃.

8. The method of claim 1, wherein the polyacid comprises at least one of:
polyacrylic acid, carboxymethyl cellulose, and copolymers thereof.

9. The method of claim 1, wherein the treatment fluid comprises at least one of:
a water-wetting surfactant, a demulsifier, and a mutual solvent.

10. The method of claim 9, wherein:
the water-wetting surfactant comprises at least one of:
alkylbenzene sulfonates, alpha-olefin sulfonates, ethoxylated alcohols, alkylphenol ethoxylates, betaines and sulfobetaines;
the demulsifier comprises at least one of:
polyoxyethylene, polyoxypropylene, polyamines, poloxamines, polyhexamethylene polyamines, polysaccharides, and ethyl lactate; and/or
the mutual solvent comprises at least one of:
ethylene glycol monobutyl ether and tetrahydrofuran.

11. A treatment fluid comprising a mixture of:
an aqueous base fluid;
an alkaline descaling agent capable of reducing scale deposits; and
a polyacid capable of preventing formation of pseudo-scale deposits.

12. The treatment fluid of claim 11, wherein the scale deposit comprises a sulfate.

13. The treatment fluid of claim 11, wherein the alkaline descaling agent comprises at least one of:
NaOH, KOH, Na₂CO₃, K₂CO₃, NaHCO₃, KHCO₃, and NH₄HCO₃.

14. The treatment fluid of claim 11, wherein the polyacid comprises at least one of:
polyacrylic acid, carboxymethyl cellulose, and copolymers thereof.

15. The treatment fluid of claim 11, wherein the treatment fluid comprises:
the alkaline descaling agent, present in an amount of 5 weight (wt %) to 20 wt %, based on the total weight of the treatment fluid.

16. The treatment fluid of claim 11, wherein the treatment fluid comprises:
the polyacid, present in an amount of 0.25 weight (wt %) to 0.5 wt %, based on the total weight of the treatment fluid.

17. The treatment fluid of claim 11, wherein the treatment fluid comprises at least one selected from the group consisting of:
a water-wetting surfactant, a demulsifier, and a mutual solvent.

18. The treatment fluid of claim 17, wherein:
the water-wetting surfactant comprises at least one of:
alkylbenzene sulfonates, alpha-olefin sulfonates, ethoxylated alcohols, alkylphenol ethoxylates, betaines and sulfobetaines;
the demulsifier comprises at least one of:
polyoxyethylene, polyoxypropylene, polyamines, poloxamines, polyhexamethylene polyamines, polysaccharides, and ethyl lactate; and/or
the mutual solvent comprises at least one of:
ethylene glycol monobutyl ether and tetrahydrofuran.

19. The treatment fluid of claim 18, wherein the treatment fluid comprises at least one selected from the group consisting of:
the water-wetting surfactant, present in an amount of 0.25 weight (wt %) to 0.5 wt %;
the demulsifier, present in an amount of 0.01 wt % to 5 wt %; and
the mutual solvent, present in an amount of 0.1 wt % to 20 wt %, based on the weight of the treatment fluid.
